(19) United States
(12) Patent Application Publication
(10) Pub. No.: US 2013/0148365 A1
(43) Pub. Date: Jun. 13, 2013

(54) FLASHLIGHT HOLDER

(71) Applicant: David Wilson, Simi Valley, CA (US)

(72) Inventor: David Wilson, Simi Valley, CA (US)

(21) Appl. No.: 13/313,525

(22) Filed: Dec. 7, 2011

(51) Int. Cl. F21V 19/00

(52) U.S. Cl. 362/382

(57) ABSTRACT

The invention comprises a flashlight holder affixed to the top of a bottle or bottle cap and that allows the flashlight to pivot about various directions and angles, all without the use of hands, thereby creating a fixed light source for use in camping or doing work in a garage or dark area where no fixed light source may be available. The invention comprises a cylinder base that fits on top of a bottle top or bottle cap, and that is fastened to a ball plate with a ball affixed to the ball plate. Two half cylinder bodies, each comprising a half ball enclosure on one end and a half opening on another end, are clamped together using clamping means. When clamped together the half ball enclosures create one ball enclosure into which the ball is inserted, and the half openings create one opening into which a flashlight is inserted.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to a device for holding a flashlight using a bottle, such as a water bottle, beer bottle, or soda bottle, as a support stand, thereby effectively transforming a flashlight into a standing lamp. The invention is useful for camping, for working in a garage, or in a dark room where light from a fixed lighting source is not readily available. With the ability to adapt a flashlight into a standing lamp, a user can use two hands to read a book, or perform work or other tasks in the dark using two hands.

Known is U.S. Pat. No. 2,563,410 issued to Micek which teaches a flashlight holder designed for use an automobile accessory, which can be adaptable for home use. The holder is adapted to serve as a stand for a flashlight, wherein the flashlight may be adjustably tilted upon the stand to direct the beam of the flashlight either up or down, and wherein the stand embodies a substantially semi-circular sleeve to removably accommodate the flashlight, wherein said sleeve is composed of a pair of jaws so connected that the presence of the flashlight between the jaws serve to tension a connection coupling the jaws so that the jaws will thus be caused to grip the flashlight, wherein each jaw carries a pair of coacting foldable legs, and wherein the the jaws may be readily separated so that the device may be collapsed to form only two major section which may be packed in minimum space. The device can also fit within a glove compartment in the dash of an automobile.

Also known is U.S. Pat. No. 2,434,440 issued to Schafranek which teaches a flashlight holder. Schafranek teaches a flash-light holder including a single piece base adapted for insertion in the back of a user's belt, the base having an extension on one side thereof, a single piece L-shaped support member having long and short arms with the short arm pivotally mounted on the base extension, the short arm in one position of the support member resting on the base at the extremity thereof, while in this position the long arm of the L extends upwardly from the base and a member of resilient material, for gripping a flash-light, rotatably mounted at the free end of said support member.

The above-referenced patents, while seeking to transform a flashlight into a lamp stand, do so in a limited manner. Neither one of the prior art allows the flashlight to rotate close to 360° nor are they designed to be releasably fixable to the top of a bottle or bottle cap.

Therefore, the object of the invention is to provide a flashlight holder designed to be affixed to the top of a bottle or bottle cap, wherein the flashlight can rotate close to 360°.

### SUMMARY

The object of the invention is to provide a means for holding a flashlight and turning a flashlight into a fixed lighting source. The invention comprises a flashlight holder that can be affixed to the top of a bottle or bottle cap with the use of a cylinder base. The cylinder base is fastened to a ball plate with a ball affixed to the ball plate. The ball fits inside of a ball enclosure formed by two half-cylinder bodies pressed against each other, where the bottom portion of the two half-cylinder bodies contain half ball enclosures. The top portion of the two half-cylinder bodies forms one opening when the two half-cylinder bodies are pressed against each other, each half-cylinder body having a half opening at its top portion. The two half bodies are clamped together through clamping means. When clamped together, the ball enclosure allows the two half bodies to pivot about the ball and the one opening to hold a flashlight. In this way, a flashlight holder can be situated atop a bottle cap or bottle top, and the flashlight can pivot about in various directions and angles, all without the use of hands to hold the flashlight.

### BRIEF DESCRIPTION OF THE FIGURES

FIG. 1 is a perspective left side view of the present invention from a bottom angle, illustrating a flash light holder without a flashlight.

FIG. 2 is a perspective right side view of the present invention from a bottom angle, illustrating said flashlight holder without the flashlight.

FIG. 3 shows the various components of the preferred embodiment of the flashlight holder separated out.

FIG. 4 is a perspective view of said flashlight holder from a top angle with a flashlight inserted in an opening formed by clamping two half-cylinder bodies.

FIG. 5 illustrates the flashlight holder affixed to the top of a bottle with the two half-cylinder bodies tilted to allow the flashlight to point to a tilted downward direction.

FIG. 6 illustrates the flashlight holder affixed to the top of a bottle with the two half-cylinder bodies tilted to allow the flashlight to point to a tilted upward direction.

### REFERENCE NUMERALS

100 . . . flashlight holder
110 . . . threaded bolt
120 . . . three-lobe wing nut
130 . . . first half-cylinder body
140 . . . second half-cylinder body
150 . . . clamping plate
160A . . . ball base
160B . . . ball
170 . . . rubber cylinder base
180 . . . screws
190 . . . curved half-enclosures
200 . . . half openings

### DETAILED DESCRIPTION

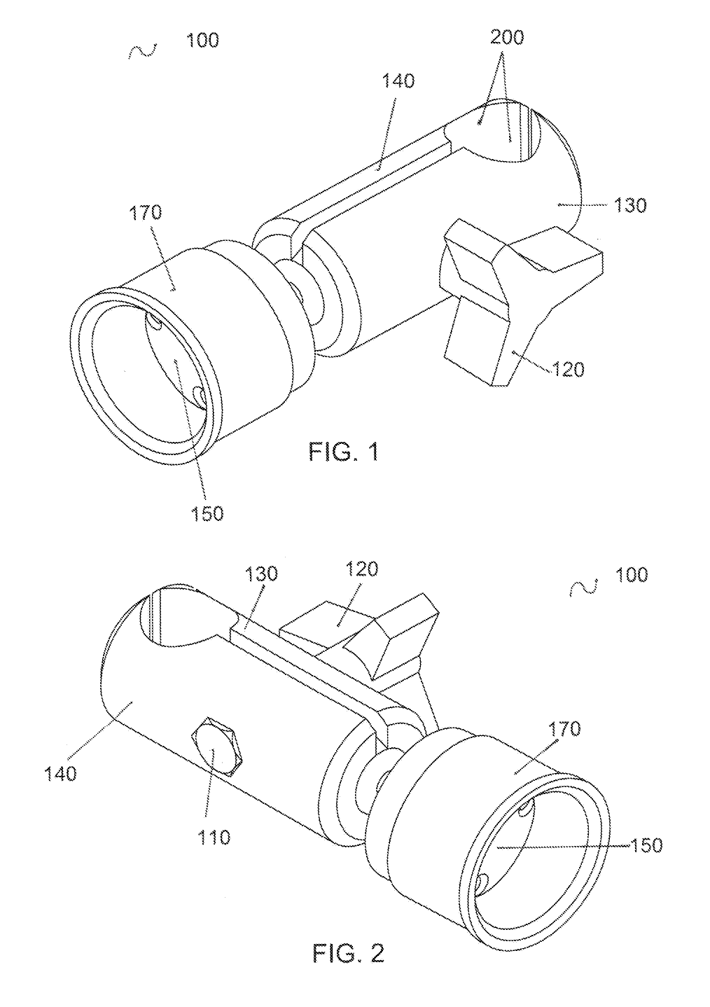

Referring to the drawings, FIGS. 1 and 2 illustrate the preferred embodiment of a flashlight holder 100 comprised of a rubber cylinder base 170 having an open bottom. The elasticity of rubber allows the rubber cylinder base 170 to expand when placing the rubber cylinder base 170 on top of a bottle top or bottle cap, and then contract to firmly grasp the bottle top or bottle cap. The rubber cylinder base 170 can be made of other material sufficient to allow the cylinder base to grasp the top of a bottle cap or bottle top. For example, a cylinder base with an inside threaded surface which can be screwed onto the top of a bottle having a threaded outer surface, can be made of plastic as the threading of the two surfaces would be sufficient to hold the flashlight holder 100 onto the top of a bottle.

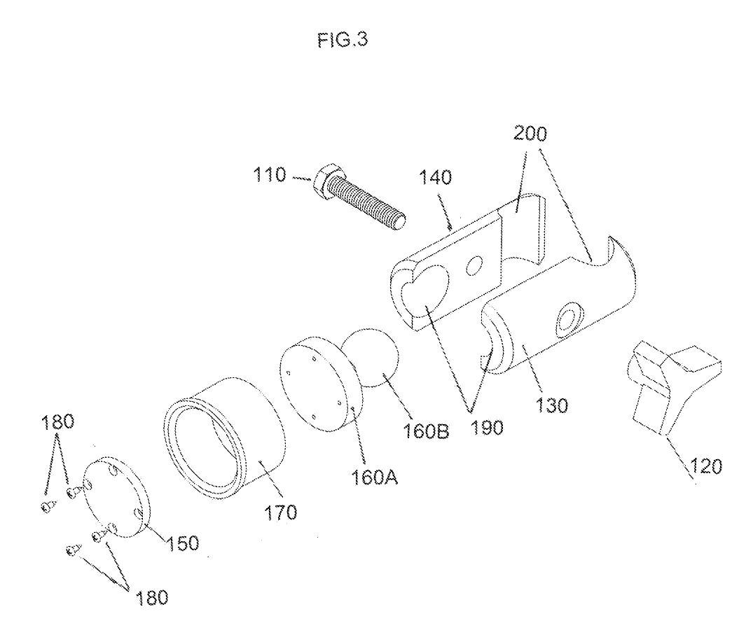

The top of the rubber cylinder base 170 may have a wall or an opening with an inner edge sufficient to hold a clamping plate 150 in place when the clamping plate 150 is inserted from the bottom of the rubber cylinder base 170. As can be seen in FIG. 3, the clamping plate 150 is affixed to a ball base 160A through the rubber cylinder base 170. The rubber cylinder base 170 holds the clamping plate 150 inside of the rubber cylinder base 170, and the clamping plate 150 is held in place by fasteners such as screws 180 that attach to the bottom of the ball base 160A.

As can further be seen in FIG. 3, a ball 106B is affixed to the ball base 106A. The ball 106B fits inside of a ball enclosure formed when a first half-cylinder body 130 is pressed against a second half-cylinder body 140, where the bottom portions of the two half-cylinder bodies contain curved half-enclosures 190. The ball enclosure provides a means for supporting upright the first half-cylinder body 130 and the second half-cylinder body 140 when the two half-cylinders are clamped together, while at the same time allowing the two half-cylinder bodies to tilt and turn in various directions and angles. The two half-cylinder bodies can be clamped together by clamping means such as a threaded bolt 110 and a three-lobe wing nut 120.

The top portions of the first half-cylinder body 130 and the second half-cylinder body 140 have half openings 200, which form one opening when the two half-cylinder bodies are pressed together. Through this one opening, a flash light may be inserted and removed using the clamping means.

FIG. 4 shows the flashlight holder 100 with a flashlight clamped between the opening formed by clamping the first half-cylinder body 130 with the second-half cylinder body 140.

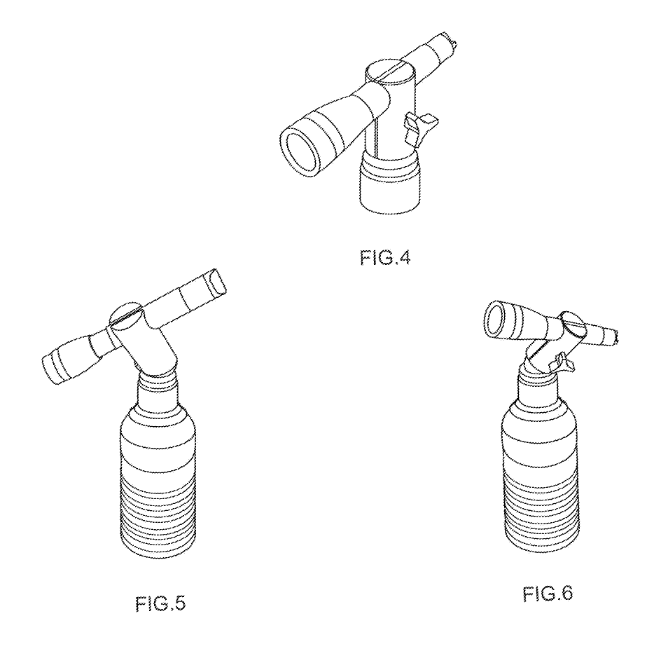

FIGS. 5 and 6 show the flashlight holder 100 affixed to the top of a bottle by the rubber cylinder base 170 and holding a flashlight through the opening formed by clamping the first half-cylinder body 130 against the second half-cylinder body 140. As can be seen in these figures, the flashlight could tilt at a nearly 360° angle.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A flashlight holder comprised of a cylinder base, a ball affixed to a ball base, and two half cylinder bodies held together by clamping means, wherein the cylinder base has a circumference and height sufficient to allow for the insertion of a bottle cap or bottle top inside the cylinder base, and wherein the two half cylinders form an opening when clamped together sufficient to support a flashlight.

2. The flashlight holder of claim 1 wherein the cylinder base is attached to the ball base through an attachment means.

3. The flashlight holder of claim 2, wherein the attachment means consists of a clamping plate inserted through the bottom of the cylinder base and fastened to the bottom of the ball base which is disposed on top of the cylinder base.

4. The flashlight holder of claim 1, wherein the cylinder base is releasably fixable to the top of a bottle top or bottle cap.

5. The flashlight holder of claim 1, wherein the cylinder base is made of rubber.

6. The flashlight holder of claim 1, wherein the two half cylinder bodies each comprise a half ball enclosure at a bottom end that forms one ball enclosure when the two half cylinder bodies are pressed together.

7. The flashlight holder of claim 6, wherein the ball fits inside the one ball enclosure such that the two half cylinder bodies can pivot around the ball.

8. The flashlight holder of claim 6, wherein the two half cylinder bodies each comprise a half opening on a top end that forms one opening when the two half cylinder bodies are pressed together.

9. The flashlight holder of claim 1, wherein the clamping means is a bolt and a nut.
